(19) United States
(12) Patent Application Publication
(10) Pub. No.: US 2025/0223088 A1
(43) Pub. Date: Jul. 10, 2025

(54) MOTOR DRIVEN POUR SPOUT WITH SMART TIMING CONTROLLER

(71) Applicant: SKYCHANNEL LTD, Wanchai (HK)

(72) Inventor: Achim Phillip Zapp, Sattahip (TH)

(73) Assignee: SKYCHANNEL LTD, Wanchai (HK)

(21) Appl. No.: 18/404,596

(22) Filed: Jan. 4, 2024

(51) Int. Cl. B65D 47/30; B65D 47/04; B65D 47/24

(52) U.S. Cl. CPC B65D 47/30; B65D 47/043; B65D 47/241; B65D 2203/10

(57) ABSTRACT

A pour spout for a bottle includes a valve system controlled by a motor to open or close a liquid channel to control timing and/or an amount of liquid dispensed. The pour spout can include a housing with an upper housing portion, a lower housing portion, and a liquid channel extending from the lower housing portion to the upper housing portion. The valve system can include a motor, a valve, and a gear train. The valve can be disposed within the lower housing portion and fluidically coupled to the liquid channel. The valve can be moved (e.g., rotated via the motor and gear train) to open or close the liquid channel. The pour spout can further include seals in the lower housing portion to establish a seal against the housing to prevent liquid leakage.

### FIELD OF DISCLOSURE

The present disclosure relates to a pour spout or a dispenser apparatus and a dispenser system for dispensing a liquid from a bottle, and more particularly to a pour spout having a motor, a magnetic stop, and a controller for controlling an amount of a liquid dispensed from a bottle.

### BACKGROUND

Spouts are popularly used for controlling dispensing of liquids. For example, a spout can be used for dispensing of liquors, wines, syrups, and other liquids, particularly in bars, restaurants, discotheques, and various venues or industries. In many applications, accurate measurement and dispensing of the liquid is important. For example, when mixing drinks alcoholic and non-alcoholic liquids are mixed together in a particular amount to create a drink of desired taste while maintaining profitability. Pouring more liquid or less liquid will not only affect the drink or a mixture quality, but also reduce profitability. Additionally, pouring the right amount of liquid fast and accurately can further add to profitability and better service to customers.

Existing spouts have several limitations including, but not limited to, pour time, air inlet control, insects and flies' contamination, battery recharge. Pour spouts are conventionally designed for dispensing a particular liquid e.g., liquor, featuring a slow flow suitable for the typically small amounts poured, such as 1 or 2 ounces. However, these spouts prove impractical for dispensing a different liquid e.g., wine due to the larger volume of liquid, resulting in extended pouring times that are inconvenient for bartenders.

Some pour spouts commonly incorporate a separate air control mechanism with a small metal ball mounted on an air tube extending inside the bottle. During pouring, liquid flows out, and air enters through the air tube, lifting the ball to allow air passage. After pouring, the ball falls back, closing the air channel by its weight and the remaining liquid's weight. Issues may arise, such as the ball getting stuck or opening with a delay when pouring liquids containing sugar. This results in inaccurate pour sizes. When a bottle is in an inclined position, challenges arise when spouts are intended for permanent inverted placement (e.g., in wall-mounted configurations), where conventional designs with a metal ball may experience sealing issues, leading to undesirable dripping.

Many spouts lack a cap to close a spout mouth. Some spouts may include a manual closure or a closure with an external weight that opens when the bottle is inclined and closes when the bottle returns to its original position. Manual closure option requires continuous action from a bartender to open the cap. External weight option involves an external arm with a counterweight, occupying additional space.

Some existing spouts employ a battery charging system through methods such as wireless charging pads, replaceable batteries, or charging with a connector cable. In all these instances, the spout must be detached from the bottle for charging, introducing a risk of mixing up bottles and spouts, resulting in the spout being incorrectly paired with a wrong bottle.

### BRIEF SUMMARY

The present disclosure provides spouts that addresses several issues related to existing/conventional spouts. In many embodiments, a pour spout for a bottle includes a valve system controlled by a motor to open or close a liquid channel to control timing and/or an amount of liquid dispensed. The pour spout can include a housing with an upper housing portion, a lower housing portion, and a liquid channel extending from the lower housing portion to the upper housing portion. The valve system can be disposed in the lower housing portion. The valve system can include a motor, a valve, and a gear train. The valve can be disposed within the lower housing portion and fluidically coupled to the liquid channel. The valve can be moved (e.g., rotated via the motor and gear train) to open or close the liquid channel. The gear train can be driven by the motor. The gear train can further move the valve between an open position and a close position to open or close the liquid channel. In many embodiments, the pour spout can further include seals to prevent liquid leakage during a pouring action. For example, the pour spout can include two silicone O-rings positioned in the lower housing portion to establish a seal against the housing to prevent liquid leakage.

The pour spouts herein provide several advantages. For example, a pour spout can have an enlarged flow channel diameter (e.g., up to 7 mm) that significantly reduces pouring time for wine or other liquid. In some embodiments, an air control system can be integrated within the spout, precisely synchronized with a motor. The spouts herein include an air tube that does not require a ball valve. To prevent liquid ingress into the air tube, a pin and an O-ring can block the air valve within an air control system inside the spout. This air valve control feature enables the spout to be used in an upright position for extended durations without liquid dripping through the air tube, addressing the issues related to the bottle in an upright position and a permanent inclined position. The present disclosure provides a pour spout integrated a cap-closing feature. The cap-closing feature may be inside the spout, hidden from a customer's view. A closing action responds to a motor movement, synchronized with the pour flow, eliminating the need for a bartender intervention. Additionally, the spout mouth can remain permanently closed, preventing fruit flies from entering. In some embodiments, a pour spout can employ a charging mechanism with magnetic clips, e.g., found in electronic watches. This design enables the spout to remain attached to the bottle during the charging process, eliminating the possibility of mix-ups.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and can or cannot represent actual or preferred values or dimensions. Where applicable, some or all features cannot be illustrated to assist in the description of underlying features. In the drawings:

FIG. 1 illustrates a housing of a pour spout for a bottle, according to various embodiments;

FIG. 2 is a cross-section view of a pour spout illustrating a valve system disposed in the housing of FIG. 1, according to various embodiments;

FIG. 3 illustrates the valve system of FIG. 2;

FIG. 4 is a cross-section of the valve system of FIG. 2 coupled to a cork.

FIG. 5 illustrates the valve system of FIG. 3 in an open state, according to various embodiments.

FIG. 6 illustrates the valve system of FIG. 3 in a closed state, according to various embodiments.

FIG. 7 illustrates a bottle presence system coupled to the valve system of FIG. 3.

FIG. 8 illustrates a printed circuit board of the pour spout of FIG. 2.

FIG. 9 is a block diagram of a processor of the PCB of FIG. 8.

FIG. 10A illustrates an assembled view of another valve system, according to some embodiments.

FIGS. 10B-10C illustrate partial views of assembled valve components around a flow channel of the pour spout.

FIG. 11A illustrates yet another valve system including an over molded valve.

FIG. 11B illustrates a cross-section view showing the over molded valve employed in a flow channel of the valve system of FIG. 11A.

FIG. 11C illustrates the over molded valve attached to a gear wheel.

FIG. 11D illustrates an assembled view of the valve system of FIG. 11A.

FIG. 12A illustrates a motor control operation where a valve is in a closed state, according to some embodiment.

FIG. 12B illustrates a motor control operation where a valve is in an open state, according to some embodiment.

FIG. 13 illustrates a liquid detection system, according to some embodiment.

FIGS. 14A-14B illustrate a bottle presence system when a bottle is not coupled to a pour spout and coupled to a pour spout, respectively, according to some embodiment.

FIGS. 15A-15B illustrate an air inlet control in a closed state and an open state, respectively, according to some embodiment.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed embodiment(s). However, it will be apparent to those skilled in the art that the disclosed embodiment(s) can be practiced without those specific details. In some instances, well-known structures and components can be shown in block diagram form in order to avoid obscuring the concepts of the disclosed subject matter.

There is a great demand for pouring right amount of liquid out of a bottle (e.g., wine, or other liquids). It should be quick and precise without a server having to watch permanently the flow and stop the pour at the right time to fill the glass.

Pour spout and systems described herein can be coupled to a bottle to dispense precise amounts of liquid. For example, the pour spout can be used to dispense precise amounts of liquors, wines, syrups, and other liquids, particularly in bars, restaurants, discotheques, and various venues. Inclining the bottle to start and stop a pouring process after a certain time, based on the bottle inclination. The pour spout herein can prevent liquid spills and enhance profitability.

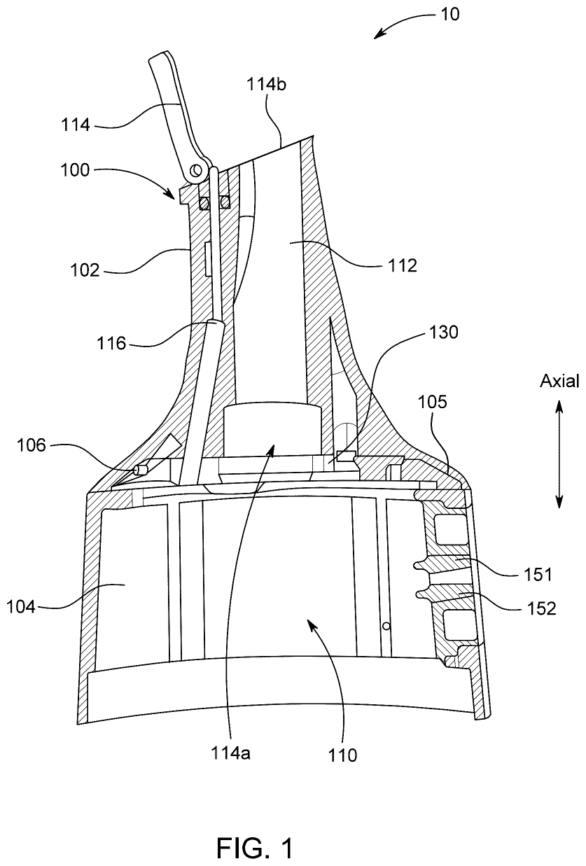

FIG. 1 illustrates a housing 100 of a pour spout 10 for a bottle, according to various embodiments. The housing 100 can include an upper housing portion 102, a lower housing portion 104, and a liquid channel 112 extending from the lower housing portion 104 to the upper housing portion 102. The upper housing portion 102 can be connected with the lower housing portion 104. In some embodiments, the upper housing portion 102 and the lower housing portion 104 can be integrally formed as a single unit. The upper housing portion 102 can have a truncated conical shape and the liquid channel 112 can run approximately at the center of the upper housing portion 102. The outer surface of the upper housing portion 102 can be straight, curved, or a combination thereof. The pouring end (e.g., 114b) of the upper housing portion 102 can be inclined to facilitate easy pouring of the liquid. The housing 100 can be constructed from a durable material like ABS plastic.

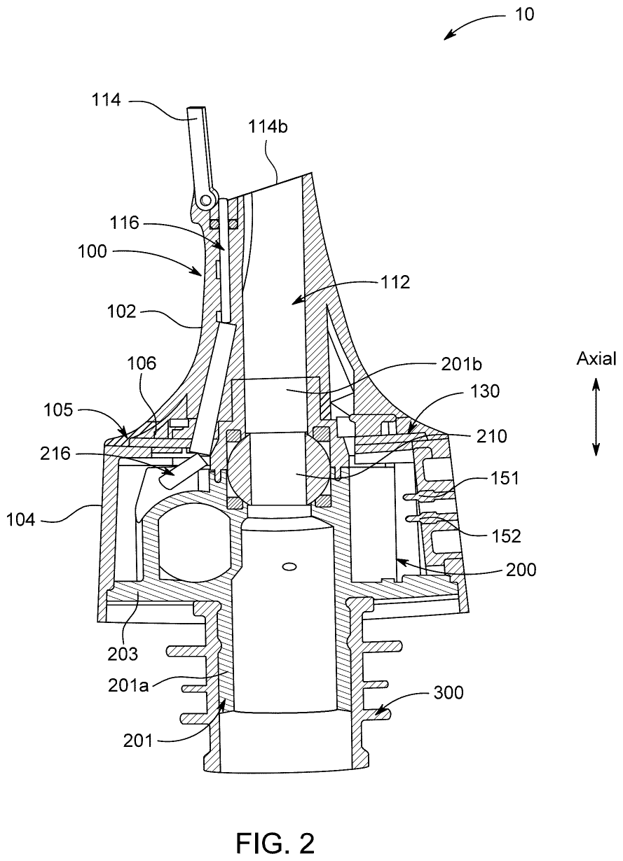

The lower housing portion 104 can include an interior compartment 110, which can be substantially hollow to receive a valve system (e.g., 200 in FIG. 2). The lower housing portion 104 can be substantially cylindrical, truncated conical, prismatic, or other shapes. The interior compartment 110 can have similar shape as the lower housing portion 104. In some embodiments, the interior compartment 110 can include one or more O-rings 151, 152 to a seal between the housing 100 and the valve system. The O-rings 151, 152 can prevent liquid from leaking from the housing 100.

In some embodiments, the liquid channel 112 can include two ends-a first end 114a (e.g., a bottom end) for receiving a liquid and an opposite second end 114b (e.g., a top end) for dispensing the liquid. The liquid channel 112 can be substantially hollow cylindrical in shape and extend axially along a length of upper housing portion 102. A first end portion of the liquid channel 112 can include an enlarged portion to receive or couple a portion of a valve system (e.g., shown in FIG. 2).

The housing 100 can further include a ring 105 disposed between the upper and the lower housing portion 104. The ring 105 can be transparent or translucent. The ring 105 has a circular shape. One or more light emitting diodes (LEDs) can be positioned on an inner side of the ring 105. The LED's can be used to display or convey a signal or data to a user. For example, LED signals (e.g., ON, OFF, or a combination thereof) can be emitted at least around a portion or an entire circumference of the ring 105. The signal can indicate for example, a pouring mode. The LED's can be connected to a printed circuit board (PCB) 130 to control the illumination of the LED.

In some embodiments, a touchpad can be provided on a portion of the outer surface of the ring 105. The touchpad can be, for example, a capacitive sensor that can respond to a finger touch or taps. The touchpad can be used to control a pouring mode. For example, the ring 105 can be configured to recognize different finger tap actions, such as tapping once, twice, or three times, to activate various pouring modes. For example, the pouring modes can be a washing mode, a cocktail making mode, or other user-defined modes. The touchpad can be communicably connected to the PCB 130. For example, the touch pad can provide input signals to the PCB 130. Then, the PCB 130 can control pouring parameters (e.g., an amount of liquid, an open close timing of a valve or a cap, or other functions discussed herein.) based on the provided at the touchpad. For example, the pouring parameters can be controlled by controlling a valve system and/or sending LED signals.

In some embodiments, a cap 114 can be movably coupled to the upper housing portion 102 to open or close the liquid channel 112. The cap 114 can be coupled at the liquid dispensing end 114b (e.g., the top end) of the liquid channel 112. The cap 114 can be configured to open before the liquid channel 112 is opened (e.g., a ball valve in an open position) and close after the liquid channel 112 is closed (e.g., a ball valve in a closed position).

In some embodiments, a linkage 116 is coupled to the cap 114 to open or close the cap 114 thereby controlling the open or close of the second end 114a of the liquid channel 112. The linkage 116 can include one or more connected links or bars. The linkage 116 can extend axially adjacent to the liquid channel 112. In the illustrated embodiment, the cap 114 is pivotably coupled to the liquid dispensing end 114b of the upper housing portion 102. As the linkage 116 moves, the cap 114 pivots to open or close the liquid channel 112. For example, the linkage 116 can push or pull the cap 114 to open or close the second end 114b of the liquid channel 112. In some embodiments, the linkage 116 can be drivably coupled to a lever (e.g., see 216 in FIG. 2). For example, the linkage 116 can move back and forth along the axial direction to open or close the cap 114.

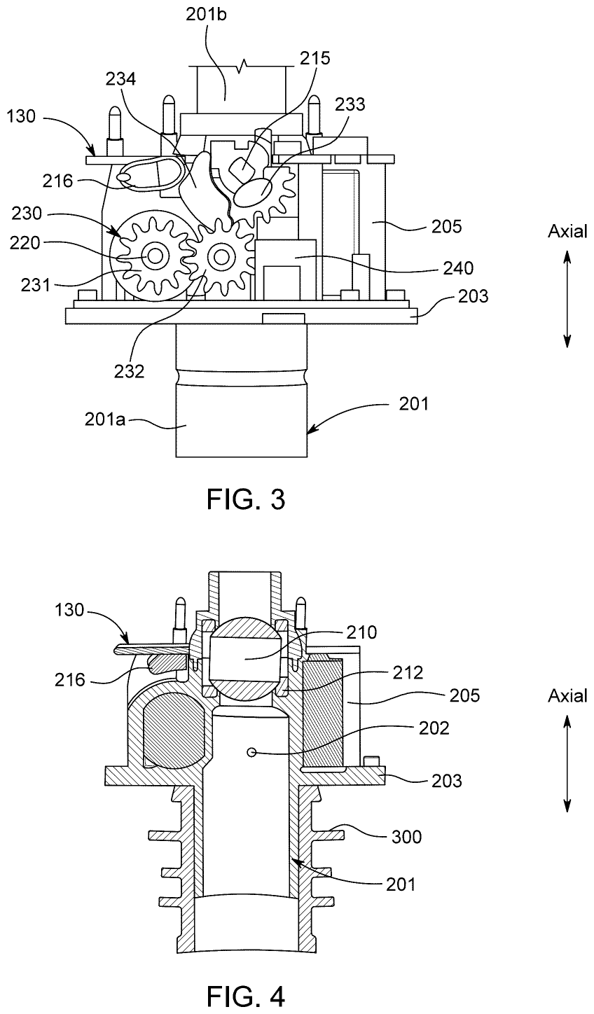

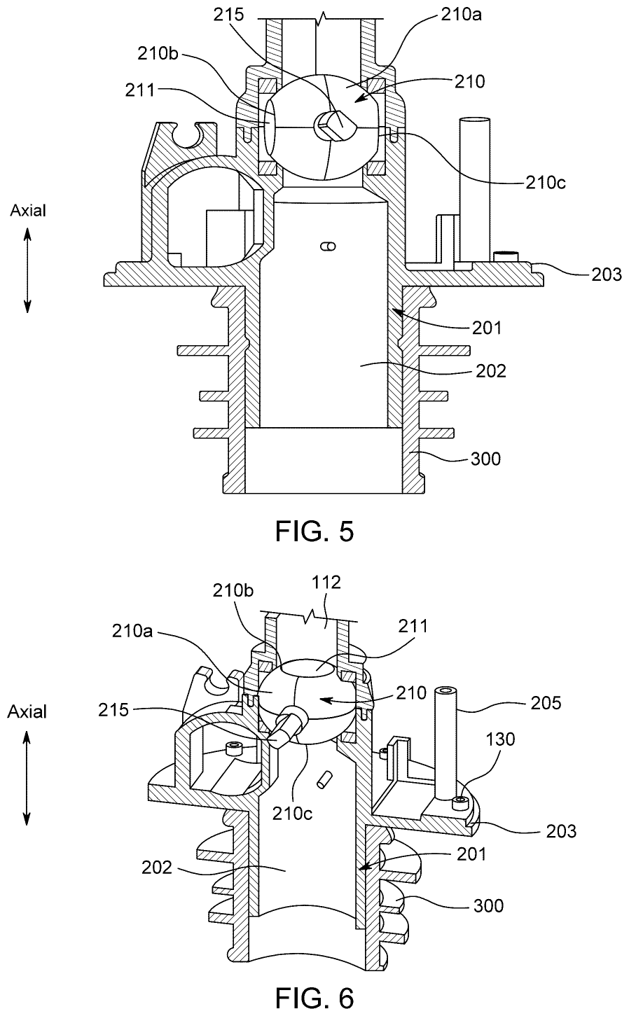

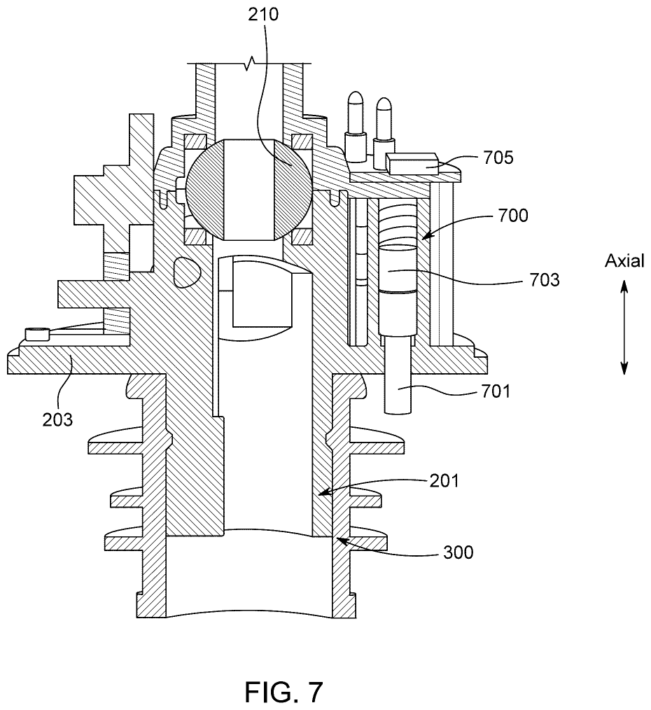

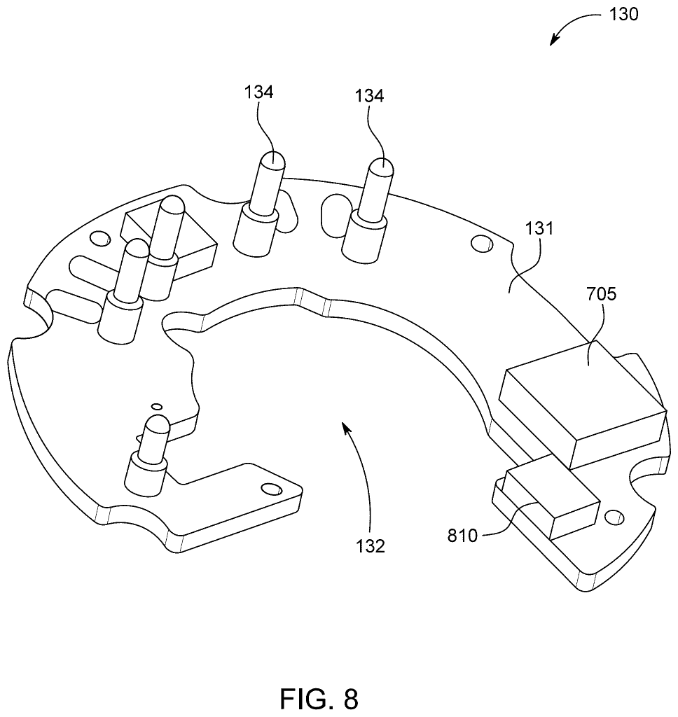

An example valve system 200 is discussed in detail in FIGS. 2-6. FIG. 2 is a cross-section view of a pour spout 10. As shown, the pour spout 10 can include a valve system 200 disposed in the lower housing portion 104, according to various embodiments. FIG. 3 illustrates an example of the valve system 200 and FIG. 4 illustrates a cross-section view of the valve system 200. FIG. 5 illustrates a ball valve (e.g., 210) in a closed pen position, and FIG. 6 illustrates the ball valve (e.g., 210) in an open position.

In some embodiments, a valve system 200 can be a compact system disposed in the lower housing portion (104 in FIG. 2). The valve system 200 can be configured to open or close the liquid channel 112 of the housing 100. The valve system 200 can include a motor 220, a ball valve 210, and a gear train 230 (e.g., see FIG. 3 and FIG. 4). The motor 220 can drive the gear train 230 to open or close the ball valve 210. The motor 220 can be activated or deactivated by the PCB 130 based on the inputs from the user. The gear train 230 can be drivably coupled to the motor 220 and the ball valve 210. The motion of the gear train 230 can be transmitted to the ball valve 210 to move the ball valve 210 between an open position and a close position to open or close the liquid channel 112.

In some embodiments, the gear train 230 can include one or more gears interconnected to each other to transmit motion from the motor 220 to the ball valve 210 and/or a lever 216. In the illustrated embodiment, in FIG. 3, the gear train 230 can include a gear 231 coupled to the motor 220, one or more intermediate gears 232, a first cam gear 233 coupled to the ball valve 210, and a second cam gear 234 coupled to the lever 216. The motor gear 231 can receive an input motion from the motor 220. The input motion can be transmitted via the intermediate gears 232 to the first cam gear 233. The input motion can also be transmitted to the second cam gear 234 to move the lever 216. Each of the first cam gear 233 and the second cam gear 234 can include cam portions (e.g., portions with no-teeth). The cam portions can have profiles designed to operate in cooperation with each other so that the lever 216 moves before the valve is in open position. In this way, the cap 114 can be opened before the liquid enters the liquid channel 112 and closes after the liquid is dispensed. It can be understood that the illustrated gear train 230 is one example of a suitable gear train and other gear systems may be implemented without limiting the scope of the present disclosure.

Referring to FIG. 3, the gear train 230 can be drivably coupled to the lever 216. For example, the gear train 230 can move the lever 216 at particular moments during a pouring action. The gear train 230 can move (e.g., pivot, translate, or rotate) the lever 216 to cause the linkage 116 to open or close the liquid dispensing end 114b of the liquid channel 112. In the illustrated embodiment, in FIG. 3, the lever 216 is pivotably or rotatably coupled to the gear train 230. However, it is possible to include a lever configured to translate in response to the gear train 230 without limiting the scope of the present disclosure.

Referring to FIGS. 2-6, the ball valve 210 can be disposed within the lower housing portion 104 and fluidically coupled to the liquid channel 112. In some embodiments, the ball valve 210 can be seated on e.g., a silicone sealing 212. The ball valve 210 can be configured to rotate by 90 degrees to open or close the liquid channel 112 (see FIGS. 5 and 6). As shown in FIGS. 5 and 6, the ball valve 210 can have a spherical body 210a with truncated ends 210b and 210c and a central bore 211 extending between the truncated ends 210b, 210c. The ball valve 210 can be rotatably coupled to the gear train 230 to move the ball valve 210 between an open position and a close position. For example, as shown in the FIGS. 3, 5, and 6, the ball valve 210 can include an arm 215. The arm 215 can be coupled to the first cam gear 233 of the gear train 230. The first cam gear 233 can include the teeth portion coupled to teeth of an intermediate gear 232, and a slot to couple with the arm 215 after ball valve 210. In this way, the intermediate gear 232 can rotate the first cam gear 233 causing the ball valve 210 to rotate.

In some embodiments, the valve system 200 can include a hollow shaft 201 configured to couple to a bottle at one end and the housing 100 at an opposite end. For example, as shown in FIGS. 2-4, the hollow shaft 201 can include a flow channel 202, a first end portion 201a and a second end portion 201b opposite to the first end portion 201a. The first end portion 201a can be coupled to the bottle (not illustrated) or a cork 300 and the second end portion 201b is coupled to the liquid channel 112 of the housing 100, as shown in FIG. 2. The ball valve 210 can be seated within the flow channel of the hollow shaft 201 to control liquid flow from the flow channel 202 to the liquid channel 112 of the housing 100 (e.g., see FIGS. 2 and 5).

Referring to FIG. 5, in the close position, the ball valve 210 is rotated by 90 degrees to close the flow channel 202 in the hollow shaft 201. In this position, the central bore 211 extends perpendicular to the flow channel 202. In the close position, the spherical shaped portion 210a of the ball valve 210 blocks any liquid from flowing from one end to an opposite end of the flow channel 202. Referring to FIG. 6, in the open position, the central bore 211 of the ball valve 210 can be axially aligned with the flow channel 202 allowing liquid flow to the liquid channel 112 of the housing 100. For example, the ball valve can be rotated via the gear train 230 as discussed above.

In some embodiments, the valve system 200 can include a mounting base 203 located between the first end and the second end of the hollow shaft (e.g., 201 see FIGS. 2-4). The mounting base 203 can include a mounting surface (e.g., a top surface) to mount the motor 220 and the gear train 230 of the valve system 200. In some embodiments, a PCB mounting surface or posts 205 can be provided to facilitate mounting of the PCB 130 at the second end portion 201b of the valve system 200.

In some embodiments, the valve system 200 can include a silicone valve 240. The silicone valve 240 can be linked to the gear train 230. The silicon valve 240 can open when the gear train 230 rotates 90 degrees, allowing air to enter the bottle to replace the liquid being dispensed. This air channel opens slightly later than the liquid channel 112, creating a small vacuum inside the bottle and preventing liquid from entering the air channel.

The present disclosure describes the valve system 200 with the ball valve 210. However, other valves may be used without limiting the scope of the present disclosure.

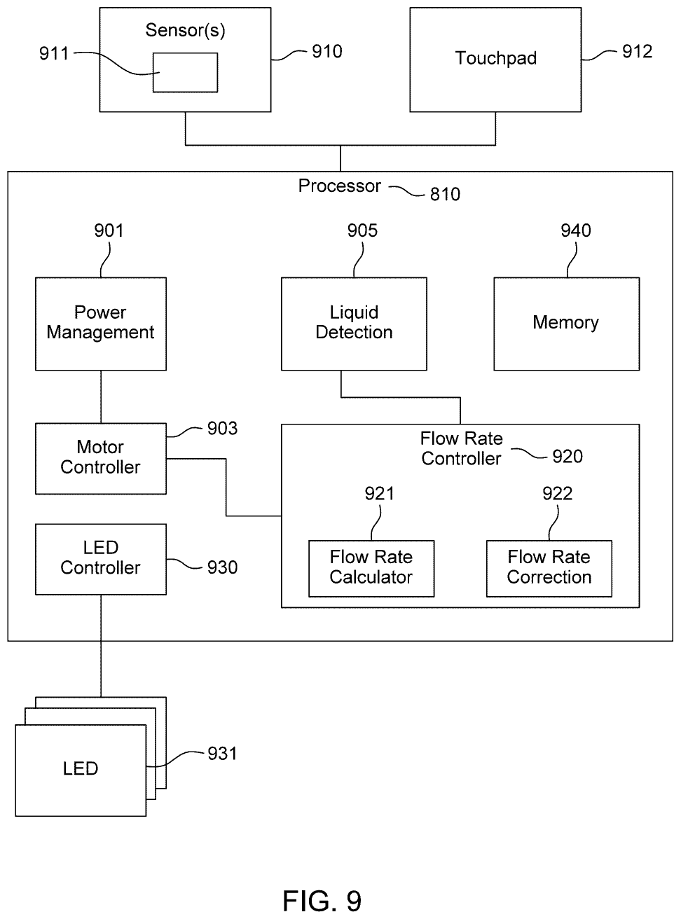

FIG. 7 illustrates a bottle presence system 700 of the pour spout 10. The bottle presence system 700 can be coupled to the valve system 200 of FIG. 3 and located within the lower housing portion 104 of the pour spout 10. The bottle presence system 700 can include a pin 701, a magnet 703, and a proximity sensor 705.

The pin 701 can extend and move axially. The pin 701 can be spring loaded and normally disconnected from the proximity sensor 705. In the illustrated embodiment, the pin 701 extends approximately perpendicular to the mounting base 203 of the valve system 200. The proximity sensor 705 can be coupled to the PCB 130 or the PCB mount 205. When a bottle is attached to the pour spout 10, the pin 701 moves upward, approaching the proximity sensor 705. In an embodiment, the pin 701 makes contact with the proximity sensor 705. This action activates the proximity sensor 705, signaling the PCB 130 to initiate the pouring process. Additionally or alternatively, a bottle presence inspection may be performed based on inputs from position switches, buttons, low-power Hall sensors, etc. These input means can be provided on or within the housing 100 of the pour spout 10 and configured to interact with a bottle when the pour spout 10 is coupled to the bottle.

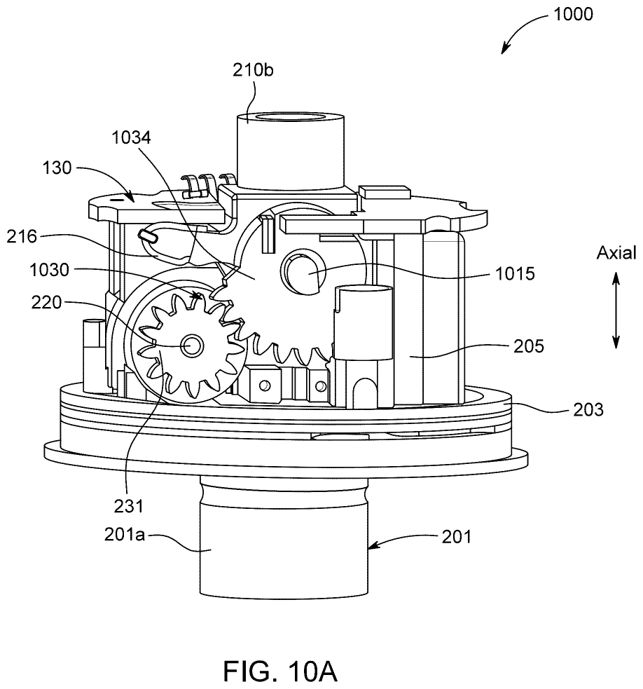

FIG. 8 illustrates an example printed circuit board (PCB) 130 of the pour spout 10 of FIG. 2. The printed circuit board can include of a PCB base 131 on which a proximity sensor 705 and a liquid detection sensor 134 can be mounted. The PCB base 131 can be shaped to conform to the shape of the valve system 200 as well as doing fit within the housing of the pour spout 10. For example, the PCB base 131 includes A centrally located cut out 135, referred as a central cut out 135. The PCB base 131 can be arc or partially circular shaped with an opening. For example, the PCB base 131 can have an end portion cut out. This allows PCB 130 to be compactly installed within the housing of the pour spout 10 (e.g., see FIGS. 1 and 2).

In the illustrated embodiment, the liquid detection sensor 134 can include two metal pins that can detect presence of the liquid in the lower housing portion 104 of the pour spout 10. When liquid is detected, the liquid detection sensor 134 can send signal the PCB 130 to commence the pouring process. For example, commencing of the pouring process can include initiate the motor 220 to cause the gear train 230 to move the ball valve 210 and the cap 114 (e.g., see FIG. 2).

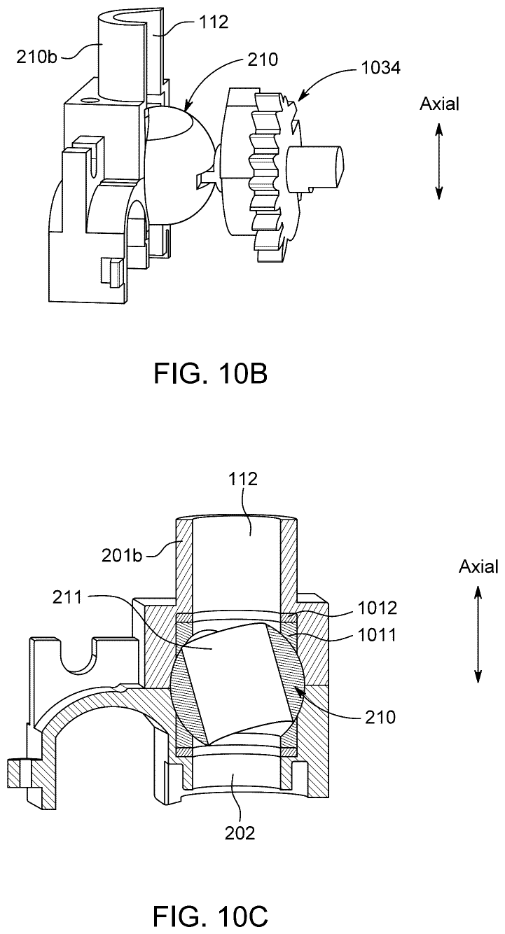

In some embodiments, the PCB 130 can include a processor 810 communicably coupled to the proximity sensor 705 and the liquid detection sensor 134. The processor 810 can be configured to perform several functions including controlling the pouring of the liquid. An example processor and its function are illustrated in FIG. 9.

FIG. 9 is a block diagram of an example processor 810 of the PCB 130 of FIG. 8. The processor 810 can be implemented a main control circuit on Bluetooth capable chip. The processor 810 can include a motor controller 903, a liquid detection module 905, a flow rate controller 920, an LED controller 930, a power management module 901, or other control modules. The processor 810 can receive data from one or more sensors (e.g., liquid detection sensor 134, bottle presence sensor, etc.) discussed herein.

In some embodiments, the motor controller 903 can be configured to control the motor 220. The motor controller 903 can include a motor current sensing circuitry, and a position detection means (e.g., switches, Hall sensors, etc.). In some embodiments, the motor controller 903 can control the motor based on inputs (e.g., single, double, or triple taps) received from the touchpad of the ring 105. For example, motor control parameters can include, but not limited to motor speed, and motor activation and deactivation. This in turn allows controlling an amount of liquid to be dispensed and/or a timing of the liquid to be dispensed.

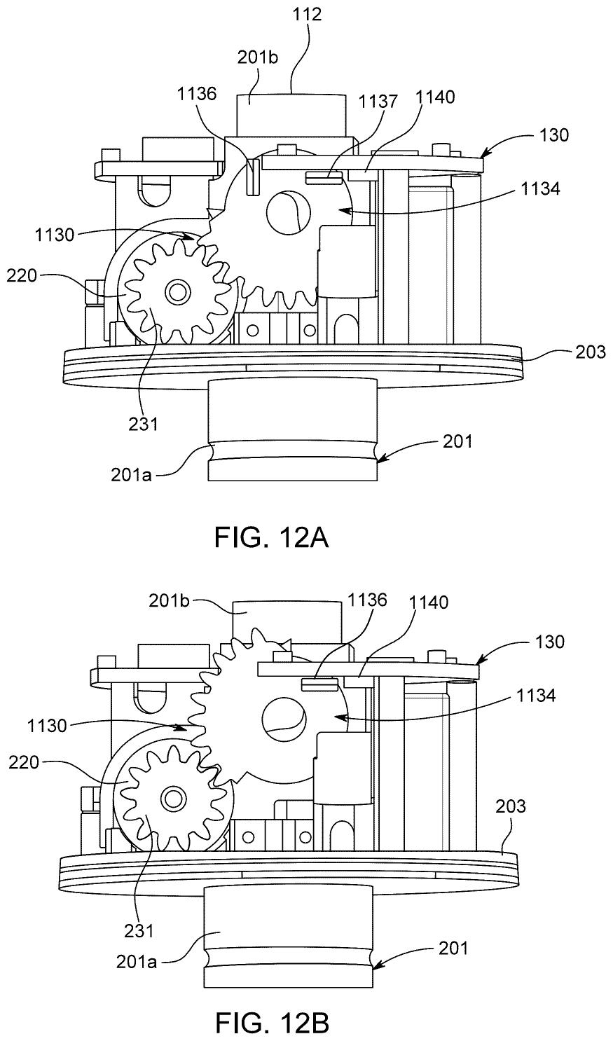

FIGS. 12A-12B illustrate example motor control operations performed by the motor controller 903. Referring to FIG. 12A, the controller 903 can be configured to perform an initial check of whether the magnets 1136 and 1137 (e.g., specifically oriented and attached to a gear wheel 1134) are in the closed position based on a sensor signal. The closed position of the valve can correspond to closed flow channel or closed pour spout. For example, a check can be performed whether a midpoint of magnet 1137 can be align horizontally with a magnet sensor 1140 (e.g., on the PCB 130). Upon determination of the closed position, the motor controller 903 can initiate the motor 220 to open the valve. Referring to FIG. 12B, the motor controller 903 can be configured to check a midpoint of the magnet 1136 aligns horizontally with the magnet sensor 1140 indicating an open position of the valve. If aligned, the motor controller 903 can send a stop command to the motor 220. In some embodiments, the motor 220 rotates 180 degrees to open or close, while the valve (e.g., a ball valve 210 in FIG. 5 or an over-molded valve see 1110 in FIG. 5) turns 90 degrees.

In some embodiments, the liquid detection module 905 can include a controllable pull-up resistor, ADC sampling to detect liquids, including signal debouncing, multiple resistance values, ADC divider. The liquid detection module 905 can receive inputs from the pins on the PCB 130, for example. The liquid detection module 905 can be configured to activate one or more modes of the pour spout 10. For example, disable, threshold, and sliver. In some embodiments, the pour modes can be a washing mode, a cocktail tips mode, or a user-defined mode.

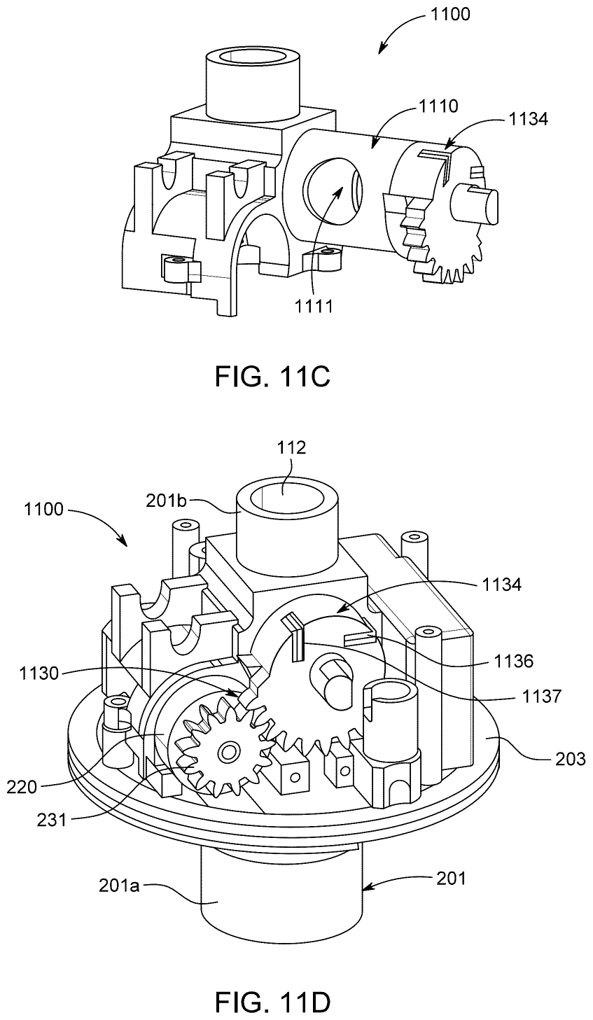

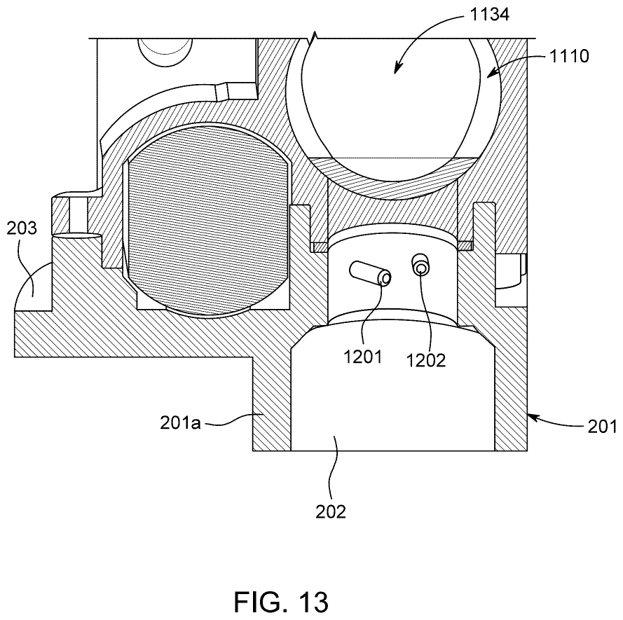

FIG. 13 illustrates example liquid detection sensors 1201 and 1202 employed in an example pour spout. The conductivity of a liquid can influence a current flowing between the two pins or liquid detection sensor 1201 and 1202. Different liquids demonstrate unique electrical conductivities. The liquid detection unit 905 of the processor 801 can receive signals from the pins 1201 and 1202 and measure the current between the two pins. Based on the measured current, a coefficient used in calculating a liquid flow rate can be adjusted. When the bottle is in a pouring position (e.g., inclined) and before opening the valve (e.g., see 210 in FIG. 5 or 1110 in FIG. 11A), the processor 801 can check for presence of the current between the two pins 1201 and 1202. If no liquid is detected, the valve will not open.

In some embodiments, the processor 810 can receive inputs from touchpad 912 (e.g., 216 in FIG. 1) or touch keys. The touchpad 912 or keys can include capacitive sensing touch surface with low power consumption placed on the inside of the translucent ring (e.g., 105 in FIG. 1) and coupled to the processor 810.

In some embodiments, the LED controller 930 can be configured to control on/off timing, and/or RGB colors of one or more LEDs 931. In some embodiments, one or more LEDs 931 can include six LEDs distributed along a circumference of the ring 105 (see FIG. 1) on an inner side of the ring 105.

In some embodiments, the sensors 910 can include an acceleration sensor 911 to detect a static angle of tilt or inclination of a bottle. The acceleration sensor 911 can be 3-axis acceleration sensor 911 with low power consumption. The acceleration sensor 911 can be installed on the PCB 130 and communicably coupled to the processor 810 to send inclination signals.

In some embodiments, the power management module 901 can include polymer battery charge management system, low-power LDO regulator with less than 2 uA Iq, DC/DC converter for driving motors, or direct battery drive or LDO power supply. In some embodiments, a pulse reset and communication may be provided. Continuous pulses can be sent to a charging port for a hard reset of a master. A single-wire serial communication through the charging port can be established. In some embodiments, the power management module 901 can include software configured to monitor battery level and charging status, sending low battery alerts when necessary.

In some embodiments, the processor 810 can include flow rate controller 920 configured to perform a flow rate calculator 921 and a flow rate correction 922. For example, the flow rate calculator 921 can be software configured to calculate flow rates based on inclination lookup tables, left and right tilt compensation, wine coefficient, and/or other apparatus (e.g., bottle, pour spout 10) difference coefficients. The flow rate correction 922 can be an automatic flow rate correction. For example, the flow rate correction can be software configured to correct flow rates based on accumulated poured amounts, equipment variances, actual bottle capacity, and output volume.

In some embodiments, the flow rate correction 922 can be software-configured to adjust flow rates based on accumulated poured amounts, actual bottle capacity, and an output volume. For example, consider pouring a liquid (e.g., wine) from a bottle with a capacity of 0.75 liters. The valve opening time can be determined based on a predetermined time. For example, the processor 801 can be pre-configured to pour 125 cl in 6 seconds, which should yield 6 glasses from the bottle.

To achieve the desired pour (e.g., 6 glasses) of liquid (e.g., wine), following configuration steps may be performed. The liquid-detecting pins (e.g., 1201, 1202 in FIG. 13) can indicate there is still liquid (e.g., wine) in the bottle after an initial pour. Pour one more time, calculate the remaining amount of liquid (e.g., wine) in the bottle, and adjust the pre-pour setting, for example, from 6 seconds to 6.2 seconds. The liquid-detecting pins (e.g., 1201, 1202 in FIG. 13) can indicate there is no liquid (e.g., wine) left in the bottle after the adjustment. In this case, change the pre-pour setting, for example, from 6 seconds to 5.8 seconds. Repeat this procedure until the correct time is identified, ensuring that the pour size is accurate for obtaining exactly 6 glasses from the bottle. This iterative process allows for fine-tuning the pour settings based on real-time feedback, and achieving consistent pour sizes.

In some embodiments, the LED controller 930 can be configured to control the LED display (e.g., via one or more LEDs of the ring 105). The LED display can provide various visual indications, including current gear, empty bottle status during pouring, mouthpiece status, data transfer failures, pouring prompts, charging status, low battery alerts, cocktail tips, empty bottle compensation, power-on messages, and cleaning mode. As an example, in a cleaning mode, the processor 810 can be configured to facilitate channel cleaning, with a method for entering and exiting cleaning mode automatically when the bottle is upright.

As an example, the spout can be programmed to offer three different pour sizes, with a standard pour size set, for example, at 2 oz. To adjust the pour size, simply touch the touch panel on the exterior of the spout housing. A single touch can correspond to a smaller size (e.g., 1 oz), indicated by one LED blinking. Two touches can change the pour size to e.g., 3 oz, with two LEDs blinking. Once the pouring process commences, the LEDs can dynamically spin around, providing a visual cue for the ongoing pour. Additionally, a washing mode can be accessible by touching the touchpad for 5 seconds. In washing mode, the valve opens and remains in this position until the touchpad is touched again for 5 seconds. The valve then returns to the closed position, ready for regular pouring.

In some embodiments, the processor 810 can be configured to include a device wake module. The device wake can be software configured to activate the pour spout 10 from a sleep mode through various triggers such as touchpad 912 presses, tilting, bottle attachment/detachment, and gear switching. For example, the touchpad 912 can be implanted on the ring.

In some embodiments, the processor 810 can be configured to perform empty bottle compensation. For example, such compensation can be achieved via software configured to compensate when the bottle is empty by analyzing proper functioning of a current gear. In some embodiment, the processor 810 can include software configured to enable dispensing of liquid using a fixed gear of the gear train (e.g., 230 in FIG. 1), allowing data tracking related to a number of cups poured and a range for the last cup difference. In some embodiments, the processor 810 can be configured to store pour data in a memory 940. For example, the process can include software configured to store pour data in the memory 940 with a capacity for 500 entries, overwriting the oldest data when full.

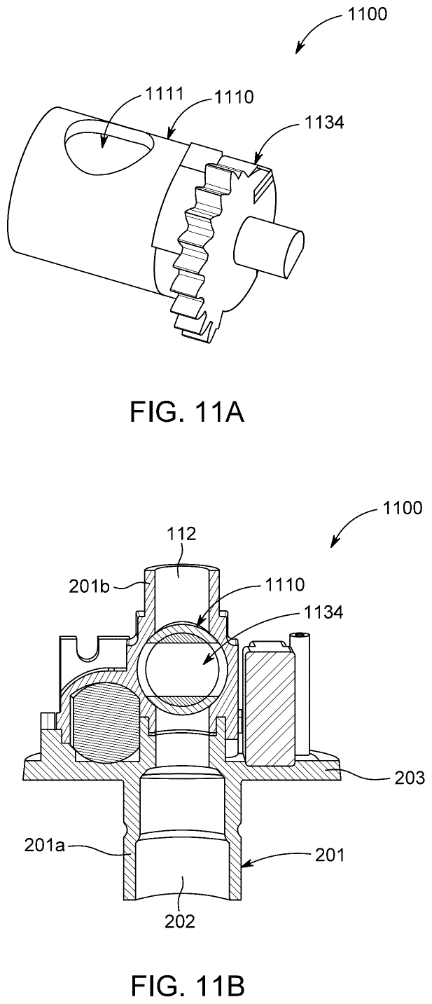

The pour spout of FIG. 1 is only an example implementation and other pour spout variations are possible. The pour spouts can have similar structure with a different valve system. Each of the pour spouts herein can include a PCB 130 and a processor 810 configured be control different valve systems and associated liquid pouring operation. FIGS. 10A-10C illustrate an example variation of a valve system 1000 that includes seals that are coupled to a flow channel around a ball valve. FIGS. 11A-11D illustrate another example variation of a valve system 1100 that can include a rod over molded with silicone configured to serve as a valve.

FIG. 10A illustrates an assembled view of the valve system 1000. FIGS. 10B-10C illustrate partial views of assembled components around a flow channel of the pour spout. The valve system 1000 can be disposed in a lower housing of a pour spout e.g., similar to that shown in FIG. 1. The valve system 1000 can have similar construction as the valve system 200 (e.g., shown in FIGS. 3-7). The valve system 1000 can include a motor 220, a motor gear 231, and a lever 216 similar to the valve system 200. Also, similar to the valve system 200, the valve system 1000 can be coupled to the hollow shaft 201 on the base 203.

The valve system 1000 can have a different gear system 1030 and seals than the valve system 200. The gear system 1030 can include reduced number of gears compared to the gear system 230 (e.g., in FIG. 3). In the illustrated embodiment, the gear system 1030 includes a motor gear 231 and a cam gear 1034, also referred as a gear wheel 1034. The cam gear 1034 can directly engage with the motor gear 231 without an intermediate gear, and drivably couple with the lever 216. The cam gear 1034 can include an arm 1015 couplable to a ball valve 210, as shown in FIG. 10B.

The valve system 1000 can incorporate a distinct Teflon ring shape 1011 and a silicone ring 1012 that compresses the Teflon ring 1011 against the ball valve 210. The Teflon ring 1011 and the silicone ring 1012 can be coupled to the flow channel 202 to prevent leakage around the ball valve 210. A slight clearance may exist between a flow channel 202 and the ball valve 210, enable smooth ball movement. The poring operation and control of amount of liquid dispensed can be similar to that discussed with respect to pour spout 10 with the valve system 200 herein.

FIG. 11A illustrates a valve system 1100 including a cam gear 1134 with a rod 1110 over molded with a silicon seal. The rod 1110 can be a nylon rod configured to serve as a valve. In this case, a ball valve may be omitted. For example, the over molded silicone seal rod 1110 can include a through hole 1111 extending transverse to a longitudinal axis of the rod 1110. The rod 1110 can be coupled to or integrally formed with a cam gear 1134.

FIG. 11B illustrates a cross-section view showing the over molded silicone seal rod 1110 employed in a flow channel 202 of the valve system 1100. When the hole 1111 is aligned with or at least partially opens the flow channel 202 liquid can flow to the channel 112. FIGS. 11C and 11D illustrates an assembled view of the valve system 1100. As shown, the assembly of the valve system 1100 to the lower housing of a pour spout can be similar to the valve system 200 shown in FIG. 3. Also, the operation can be similar to the valve system 200.

The rod 1110 provides several advantages. For example, the rod 1110 with the silicone over-molded seal is completely enclosed within a flow channel, preventing any liquid from penetrating between the silicone seal and the flow channel.

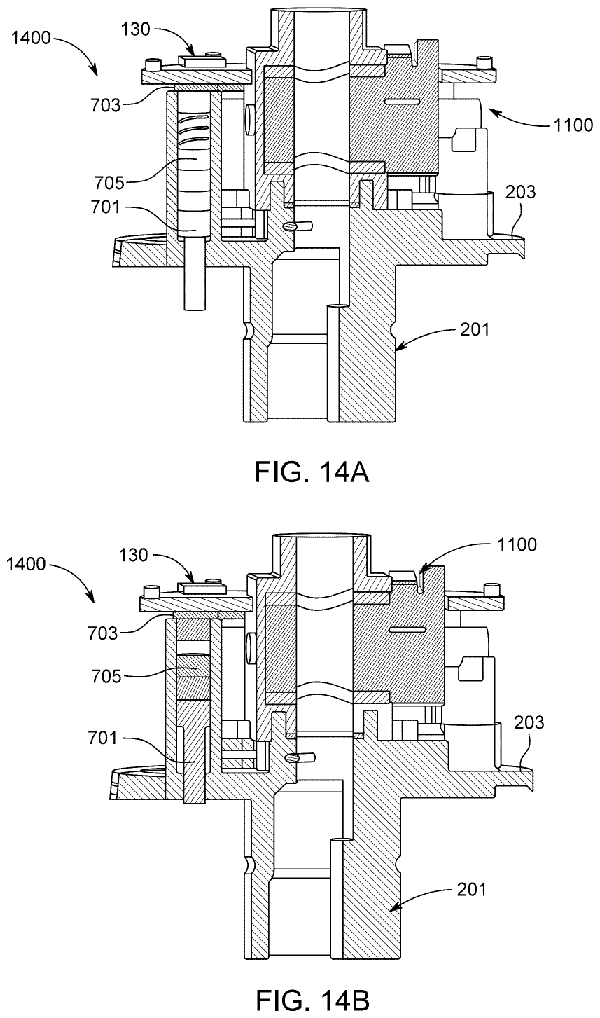

FIGS. 14A-14B illustrate a bottle detection system 1400 implement in a pour spout. The bottle detection system 1400 can be similar to the detection system 700 of FIG. 7. FIG. 14A illustrate a configuration when no bottle present and FIG. 14B illustrate a configuration when a bottle is present. As shown in FIG. 14A, the bottle detection system 1400 can be formed in the lower housing portion of the pour spout. The system 1400 can include a pin 701, a magnet 703, and a sensor 705. When a bottle is not present, the pin 703 is pushed down by a spring. A distance between the magnet 703 and the sensor 705 can be a predetermined distance (e.g., 7 mm or more) associated with a weak sensor signal at the sensor 705. As shown in FIG. 14B, when a bottle is present, the pin 701 is pushed by the bottle. The distance between the magnet 703 and the sensor 705 reduces (e.g., 3.5 mm) resulting in a strong signal having an intensity greater than the weak signal. The signals can be processed by the processor 801 to determine whether a bottle is present or not. If no bottle is detected, the processor 801 can control the valve (e.g., 1134) to remain closed, and no pouring is registered even when the bottle is inclined. This ensures that the pouring process is only initiated when a bottle is properly detected, preventing any unintended operation in the absence of a bottle.

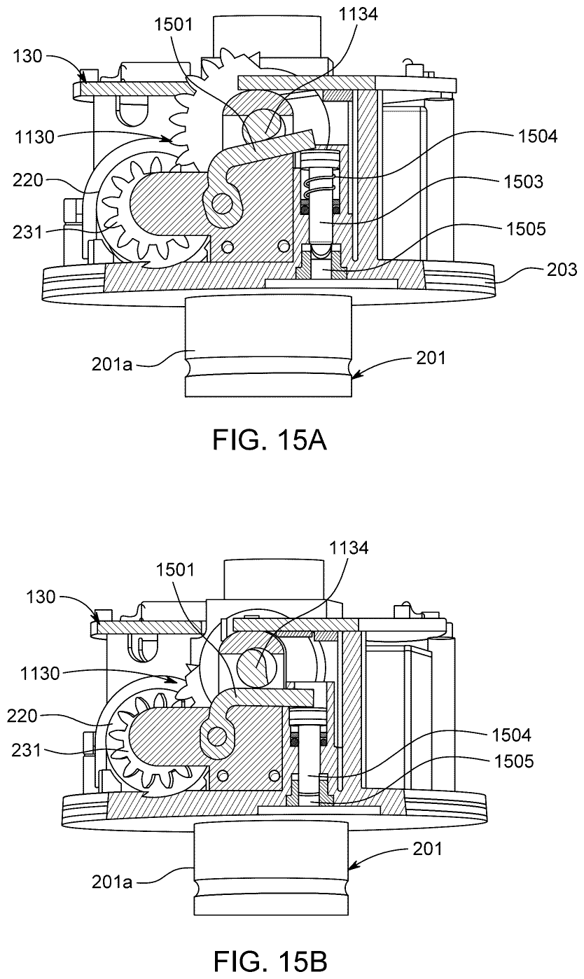

In many embodiments, FIGS. 15A-15B illustrate an air inlet control system. FIG. 15A illustrates a state when an air inlet is open and FIG. 15B illustrates another state when the air inlet is closed. The air inlet control system 1500 can be configured to respond to movements of the motor 220. As shown, the air inlet control system 1500 can include an air arm 1501 with a pivot end and a cantilever end, a pin 1503 coupled to a spring 1504, and a silicone ring 1505. The pivot end of the air arm 1501 can be pivotably coupled in the motor 220 and the cantilever end can be engaged with a gear wheel (e.g., 1134). In response to turning of the motor 220, the air arm 1501 turns such that the spring 1503 pushes the pin into the open position, allowing free airflow through the silicone ring 1505. As shown in FIG. 15B, the gear wheel (e.g., 1134) and valve (e.g., 1111) are in the closed position. The eccentricity of the gear wheel can keep the air arm 1501 in the closed position as long as the arm 1501 touches a round part of the gear (e.g., 1134).

Some or all of the processes and functions described herein, or variations, and/or combinations thereof may be performed under the control of one or more processors configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

As used herein, “processor” or “computer system” includes any of various computer systems or components thereof. The processor can broadly refer to a processor, a microcontroller, a microcomputer, a programmable logic controller (PLC), an application specific integrated circuit, and other programmable circuits, and these terms are used interchangeably herein. In the various embodiments, memory may include, but is not limited to, a computer-readable medium, such as a random access memory (RAM). Alternatively, a compact disc-read only memory (CD-ROM), a magneto-optical disk (MOD), and/or a digital versatile disc (DVD) may also be used. Also, additional input channels may include computer peripherals associated with an operator interface such as a mouse and a keyboard. Alternatively, other computer peripherals may also be used that may include, for example, a scanner. Furthermore, in some embodiments, additional output channels may include an operator interface monitor and/or a printer.

The processor also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

The particular features, structures or characteristics can be combined in any suitable manner in one or more embodiments. Further, it is intended that embodiments of the disclosed subject matter cover modifications and variations thereof.

It is to be understood that terms such as “distal,” “proximal,” “top,” “bottom,” “front,” “side,” “length,” “inner,” and the like that can be used herein merely describe points of reference and do not necessarily limit embodiments of the present disclosure to any particular orientation or configuration. As used herein “first,” “second,” “third,” etc., merely identify one of a number of portions, components, steps, operations, functions, and/or points of reference as disclosed herein, and likewise do not necessarily limit embodiments of the present disclosure to any particular configuration or orientation.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A pour spout for a bottle, the pour spout comprising:
a housing comprising an upper housing portion, a lower housing portion, and a liquid channel extending from the lower housing portion to the upper housing portion;
a valve system disposed in the lower housing portion and configured to open or close the liquid channel, the valve system comprising:
a motor;
a valve disposed within the lower housing portion and fluidically coupled to the liquid channel, the valve being configured to open or close the liquid channel; and
a gear train drivably coupled to the motor and configured to move the valve between an open position and a close position to open or close the liquid channel; and
two silicone O-rings positioned in the lower housing portion to establish a seal against the housing to prevent liquid leakage.

2. The pour spout of claim 1, further comprising:
a cap movably coupled to the upper housing portion to open or close a liquid dispensing end of the liquid channel, the cap being configured to open before the valve opens the liquid channel and closes after the valve is closed.

3. The pour spout of claim 2, further comprising:
a linkage coupled to the cap; and
a lever coupled to the linkage and the gear train such that the gear train is configured to move the lever to cause the linkage to open or close the liquid dispensing end of the liquid channel.

4. The pour spout of claim 1, further comprising:
a printed circuit board (PCB) comprising a controller comprising a setup menu indicating one or more pouring modes, and one or more LEDs; and
a translucent ring coupled to the PCB, the translucent ring comprising a touchpad configured to respond to one or more fingertip presses, the finger presses allowing a user to select a pouring mode from the one or more pouring modes programmed within the setup menu of the controller.

5. The pour spout of claim 4, wherein the PCB further comprises:
a proximity sensor configured to detect the bottle and activate the valve system; and
a liquid sensor to detect presence of a liquid.

6. The pour spout of claim 4, wherein the translucent ring is configured to recognize different fingertip actions to activate the pouring mode, the pouring mode comprising at least one of a washing mode, a cocktail tips mode, or a user-defined mode.

7. The pour spout of claim 4, wherein the translucent ring is configured to receive a tapping action comprising a single tap, a double tap, or a triple tap.

8. The pour spout of claim 4, wherein the translucent ring is located between the upper housing portion and the lower housing portion.

9. The pour spout of claim 4, wherein the translucent ring is configured to display LED signals emitted all around its circumference to communicate a wide range of data and information to the user.

10. The pour spout of claim 1, the valve system comprises:
a hollow shaft comprising a flow channel, a first end portion and a second end portion opposite to the first end portion, the first end portion is couplable to the bottle and the second end portion is couplable to the liquid channel of the housing; and
a mounting base located between the first end and the second end of the hollow shaft.

11. The pour spout of claim 10, wherein the mounting base comprises a mounting surface to mount the motor and the gear train of the valve system.

12. The pour spout of claim 10, wherein the valve is seated within the flow channel of the hollow shaft to control liquid flow from the flow channel to the liquid channel of the housing.

13. The pour spout of claim 12, wherein the valve has a spherical body with truncated ends and a central bore extending between the truncated ends.

14. The pour spout of claim 13, wherein the valve is rotatably coupled to the gear train to move the valve between an open position and a close position.

15. The pour spout of claim 14, wherein in the open valve position, the central bore is axially aligned with the flow channel to allow liquid flow to the liquid channel of the housing, and in the close valve position, the central bore is rotated by 90 degrees to close the flow channel.

16. The pour spout of claim 1, wherein the valve is a ball valve configured to rotate by 90 open or close the liquid channel.

17. The pour spout of claim 1, wherein the valve comprises a rod over-molded silicone seal, wherein the rod comprises a through hole extending transverse to a longitudinal axis of the rod, the rod being coupled to the gear to align the hole for opening or closing the liquid channel.
